(19) United States
(12) Patent Application Publication
(10) Pub. No.: US 2007/0143348 A1
(43) Pub. Date: Jun. 21, 2007

(54) DEMOGRAPHIC ASSESSMENT AND PRESENTATION FOR PERSONAL AREA NETWORKS

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/677,045

(22) Filed: Feb. 20, 2007

Related U.S. Application Data
(63) Continuation-in-part of application No. 11/383,197, filed on May 12, 2006.
(60) Provisional application No. 60/723,021, filed on Oct. 1, 2005.
(60) Provisional application No. 60/776,285, filed on Feb. 24, 2006.

(51) Int. Cl. G06F 7/00

(52) U.S. Cl. 707/104.1

(57) ABSTRACT

Embodiments of the present invention comprise methods and apparatus that enable a user of a portable computing device to collect and view demographic data representing the statistical makeup of a group of other users in his or her surroundings. More specifically, embodiments of the present invention enable a user of a first portable computing device to collect and view demographic data representing the statistical makeup of a group of users of other portable computing devices, said portable computing devices engaged in an ad-hoc network. Embodiments of the present invention allow a user to log statistics with respect to time, date, and/or location. Embodiments of the present invention also allow a user to view statistics in graphical form.

This application is a continuation-in-part of U.S. patent application Ser. No. 11/383,197 filed May 12, 2006, which claims the benefit of U.S. Provisional Patent Application No. 60/723,021 filed Oct. 1, 2005, which are incorporated in their entirety herein by reference. This application also claims the benefit of U.S. Provisional Patent Application No. 60/776,285 filed Feb. 24, 2006, which is incorporated in its entirety herein by reference.

This application is also related to U.S. patent application Ser. No. 11/344,612 filed Jan. 31, 2006 and U.S. patent application Ser. No. 11/619,607 filed Jan. 3, 2007, both of which claim the benefit of U.S. Provisional Patent Application No. 60/717,591 filed Sep. 17, 2005, all of which are incorporated in their entirety herein by reference. This application is also related to U.S. Provisional Patent Application No. 60/774,777 filed Feb. 17, 2006, which is incorporated in its entirety herein by reference.

### BACKGROUND OF THE INVENTION

1. Field of the Invention

The present invention relates to mobile demographic tracking methods and apparatus for devices connected by ad-hoc networks. The present invention also relates to social networking applications that track the location of a plurality of users of portable electronic devices and enable information exchange between users and/or person-to-person communication between users.

2. Discussion of the Related Art

Mobile social networking systems are generally operated as managed services by application service providers (ASPs) and operate using several common characteristics. For example, users typically create unique personal profiles that include basic information including age, gender, user name, interests, profession, history, testimonials and information about their network. In some applications, users map their relationship with other members, either by inviting other members to join their network (e.g., Friendster and/or Linkedin), or by using software to scan existing relationships recorded in computer contact software (e.g., Spoke and/or Visible Path). Most commonly, these applications provide such functions as friend-finding, text-dating and community message aggregation. Friend-finder applications (e.g., Dodgeball) can identify the location of the user and the friend of a user and alert the user when the friend is within a certain proximity. Such applications may also consult the relationship map and identify “friends of friends” who have announced they are within a certain range of the user's vicinity. Text-dating applications (e.g., MobiVibe) allow users to connect with new friends who meet age and gender criteria, enabling users to communicate, e.g., to exchange text messages. Community message aggregators (e.g., Upoc) distribute messages from one member to all members within a specific community. A system disclosed in U.S. Patent Publication No. 2005/0177614, which is hereby incorporated by reference, enables like-minded mobile device users to meet one another, on a permission basis, based upon one or more factors, such as: each user's reciprocal networking objective, the nature of the industry in which the user works, the user's level within the management hierarchy of his or her company, any specialty function the individual may possess, and so on. A similar system that is constructed for use within Bluetooth networks and other peer-to-peer networking configurations is disclosed in U.S. Patent Publication No. 2005/0174975, which is hereby incorporated by reference.

A problem with prior art mobile social networking systems is that they do not allow a user to gain information about groups of users in their immediate vicinity, compute demographic statistics for said groups of users, and display the demographic information in convenient form. Such features and functions would be valuable for they would enable a user to better understand demographic makeup of the people in their surroundings, currently and/or over a period of time.

### SUMMARY OF THE INVENTION

Several embodiments of the invention advantageously address the needs above as well as other needs by providing methods and apparatus for using data related to a user's gender to improve the organization of documents retrieved in response to a search query.

In one embodiment, the invention can be characterized as a system for mobile demographic profiling across ad-hoc networks, comprising: a first portable computing device operated by a first user, the first portable computing device including a processor, a memory, a display, and a wireless communication transceiver, the wireless communication transceiver enabling the establishment of an ad-hoc network with a plurality of second portable computing devices; wherein the processor of the first portable computing device is operative to: receive user profile data originating from each of the plurality of second portable computing devices over the ad-hoc network, the user profile data indicating at least one demographic characteristic of one of a plurality of users of the plurality of second portable computing devices; store a representation of demographic data received; compute a statistical demographic profile of the plurality of users of the plurality of second portable computing devices using the demographic data received; and display a representation of the statistical demographic profile on the display of the first portable computing device.

In another embodiment, the invention can be characterized as a method for mobile demographic profiling across ad-hoc networks, comprising: receiving at a first portable computing device user profile data originating from each of a plurality of second portable computing devices over an ad-hoc network, the user profile data indicating at least one demographic characteristic of one of a plurality of users of the plurality of second portable computing devices; storing a representation of demographic data received; computing a statistical demographic profile of the plurality of users of the plurality of second portable computing devices using the demographic data received; and displaying a representation of the statistical demographic profile on a display of the first portable computing device.

In a further embodiment, the invention can be characterized as a method for demographic profiling across portable computing devices, comprising: receiving on a first portable computing device, user profile data originating from each of a plurality of second portable computing devices, the user profile data indicating at least one demographic characteristic of a user of one of the plurality of second portable computing devices; computing a statistical demographic profile describing a plurality of users of the plurality of second portable computing devices, the computing being performed using the user profile data received; and displaying a representation of the statistical demographic profile of the plurality of users at the first portable computing device, the representation indicating how the plurality of users vary statistically with respect to the at least one demographic characteristic.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 illustrates an example spatial environment according to one embodiment of the present invention As shown a user of a portable computing device resides within a special environment that includes a plurality of other users of portable computing devices;

FIG. 2 illustrates a system including a plurality of portable computing devices in communication through an ad-hoc network in accordance with some embodiments of the present invention;

FIG. 3 shows a portable computing device displaying demographic statistics in textual form in accordance with some embodiments of the present invention;

FIG. 4 shows a portable computing device displaying demographic statistics in graphical form as a bar graph in accordance with some embodiments of the present invention;

FIG. 5 shows a portable computing device displaying demographic statistics in graphical form as a pie chart in accordance with some embodiments of the present invention;

FIG. 6a shows a portable computing device displaying demographic statistics in graphical form as a histogram in accordance with some embodiments of the present invention;

FIG. 6b shows a portable computing device displaying demographic statistics in graphical form as a histogram with two sets of bars, each representing a different gender in accordance with some embodiments of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Some embodiments of the present invention comprise methods and apparatus that enable a user of a portable computing device to collect and view demographic data representing the statistical makeup of a group of other users in his or her immediate surroundings. More specifically, some embodiments of the present invention enable a user of a first portable computing device to collect and view demographic data representing the statistical makeup of a plurality of other users of other portable computing devices in his or her immediate vicinity, said other portable computing devices engaged in one or more local ad-hoc networks with said first portable computing device. In some such embodiments the local ad-hoc networks are enabled using Bluetooth networking technologies. In addition, some embodiments of the present invention allow a user to log demographic statistics with respect to time, date, and/or location as he or she traverses the physical world and said first portable computing device engages in new and/or varying ad-hoc networks with portable computing devices of other user's that temporarily reside within certain proximity of said first portable computing device. Some embodiments of the present invention also allow a user to view demographic statistics in graphical form upon said first portable computing device. In addition, some embodiments of the present invention allow a user to selectively adjust the range of the demographic data collection and/or viewing process, varying the number of hops between devices used in the collection and/or statistics viewing process. In addition, some embodiments of the present invention allow a user to selectively set the demographic characteristic(s) that are used in the collection, generation, and/or display of demographic statistics by and/or upon said first portable computing device. In some such embodiments the user may define and/or select a combination of demographic characteristics that are used in the collection, generation, and/or display of demographic statistics by and/or upon said first portable computing device. In some such embodiments a user interface is provided upon said first portable computing device that enables a user to set and/or select characteristics and/or combinations of characteristics that are used in the collection, generation, and/or display of demographic statistics. In some embodiments the demographic characteristics supported include one or more of (and/or one or more combinations of) user gender, age, marital status, couple status, political bent, political party affiliation, musical tastes, sports team preferences, school affiliation, organizational affiliation, status as a local or visitor to a particular current location, city of residence, state of residence, country of residence, and/or primary language spoken.

In this way a user may traverse the physical world and be provided with a display of statistics in numerical and/or graphical form that represent the demographic makeup of other users within his or her immediate surroundings. For example a user may view the percentage of males versus females within certain proximity of his or her current physical location by looking upon the display of his or her portable computing device. Similarly a user may view the percentage of Democrats versus Republicans within certain proximity of his or her current physical location by looking upon the display of his or her portable computing device. Similarly a user may view the percentage of locals versus visitors within certain proximity of his or her current physical location by looking upon the display of his or her portable computing device. Simiularly a user may view the percentage of single females between the ages of 19 and 29 within certain proximity of his or her current physical location by looking upon the display of his or her portable computing device. In such an embodiment a combination of three demographic characteristics are used in combination—gender, age, and marital status, when computing and displaying the desired demographic statistics to the user. Thus a user may request demographic statistics for a local proximity using the highly customizable interface of some embodiments of the present invention.

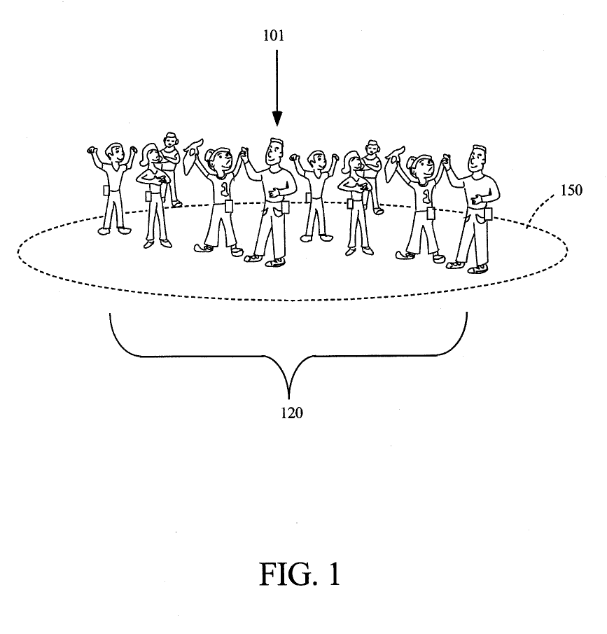

Referring to FIG. 1, illustrated is an example spatial environment of some embodiments of the present invention including a first user 101 who resides within a local space 150. The first user has upon his person a portable computing device (not shown) that is equipped with ad-hoc networking capabilities. For example, the portable computing device could be a smart phone device with a Bluetooth type of ad-hoc networking capability. As shown, the local space 150 is an area of certain size and shape around first user 101. In some embodiments the local space 150 may also be represented as a volume of certain size and shape around the user 101. The area (or volume) need not be of a regular shape, although in some common embodiments the area is a circular region as shown in the figure. More specifically, in some embodiments the local space is a circular area of radius r where r is the communication range of the ad-hoc networking technology included within said portable computing device. For example for current Bluetooth networking technologies, a typical range is 10 meters. Thus in some common embodiments the local space 150 may be represented generally as a circular area around the user 101 with a radius of approximately 10 meters. It should be noted that in some embodiments the local space 150 may be larger than the device-to-device communication range of the ad-hoc networking technology employed. This is achieved by allowing data exchange from a first device to a third device through an intervening second device, thereby extending the communication range from the first device to the third device of up to double the nominal communication range. In theory such message passing through intervening devices can extend the local space indefinitely if a spatial area has a sufficient number of enabled devices that are appropriately spaced and are communicating in a appropriate arrangement. In reality, the common embodiments of the present invention may only use this technique for a one or two levels of message passing, thereby extending the size of the local space to a small multiple of the nominal device-to-device communication range.

As also shown in FIG. 1, the local space 150 includes a plurality of other users 120 who at that current moment in time reside within certain proximity of first user 101. Each of said plurality of other users 120 has upon his or her person a portable computing device (not shown) that is equipped with ad-hoc networking capabilities. For example, the portable computing devices upon each of the persons of said plurality of other users 120 could be a smart phone type device with Bluetooth networking capability or could be a personal digital assistance (PDA) type device Bluetooth networking capability or could be a wrist worn, head worn, or otherwise body-worn portable computing device with ad-hoc networking capability.

Some embodiments of the present invention are enabled through a configuration in which each of said plurality of portable computing devices on the person of each of said plurality of other users 120 exchanges data with the portable computing device of said first user 101. The data exchange may be direct data exchange between a portable computing device of one of said other users 120 and said portable computing device of said first user 101, or the data exchange may be performed through one or more intervening portable computing devices. The data exchange includes the repeated passing of demographic characteristic information about the user of one portable computing device to other portable computing devices within said local space 150. In particular, the data exchange includes said portable computing device of said first user 101 collecting demographic characteristic information that originates from each of said other portable computing devices. In addition said portable computing device of said first user 101 sends demographic characteristic information about said first user 101 directly, or through intervening computing devices, to each of said other portable computing devices. In this way, each of the other portable computing devices of said plurality of other users 120 receives and stores demographic characteristic information about said first user 101 and the portable computing device of said first user 101 receives and stores demographic characteristic information about each of said plurality of other users 120.

Considering that any of said plurality of users 120 may also be considered a first user 101 within a particular local space 150 around that user, it becomes clear that some embodiments of the present invention enable a portable computing device of any first user 101 within a particular local space 150 to collect and store demographic characteristic information about a plurality of other users within that local space AND to send demographic characteristic information about that first user to said plurality of other users within that local space. In this way, each enabled portable computing device within a certain local area 150 may automatically form one or more ad-hoc networks with other enabled portable computing devices with that certain local area 150 and automatically exchange demographic characteristic information such that each portable computing device collects, stores, and maintains a current data store that indicates the collective demographic characteristics of all other users of such enabled portable computing devices within that area 150 around that device.

In addition, each enabled portable computing device of some embodiments of the present invention are operative to perform statistical processing upon the collected demographic characteristic information to derive demographic statistics about the users of said enabled portable computing devices currently residing within said local space. The demographic statistics, may for example, determine the percentage of such users who are male versus female. Similarly the demographic statistics may for example, generate a histogram for certain designated age groupings of users of enabled portable computing devices present within the local space. Similarly the demographic statistics may for example, correlate a combination of individual demographic characteristics such as age, gender, and marital status. In this way the demographic statistical processing routines of some embodiments of the present invention may determine, for example, the percentage of women who are unmarried and who are between 19 and 29 years old who are then currently within the local space. In addition the statistical processing routines may review data collected over a period of time, for example determining the percentage of women who are unmarried and who are between 19 and 29 years old who passed within the local space over a period of 15 minutes. Such demographic statistical information is then presented to the user of that portable computing device in textual and/or graphical form. In these ways some embodiments of the present invention provide for a highly flexible and powerful tool for collecting, processing, and displaying demographic statistics about other users who are currently within and/or who recently passed within a certain local proximity of a first user's current location.

Thus some embodiments of the present invention enable a first portable computing device within a local space to collect demographic characteristic information about a plurality of other users of enabled portable computing devices within that local space over one or more ad-hoc networks. Furthermore, some embodiments of the present invention enable said first portable computing device to perform a mathematical analysis upon the collected information and thereby compute demographic statistics about the plurality of other users of enabled portable computing devices within said local space. Some embodiments of the present invention are configurable by users such that the user of said first portable computing device may indicate which demographic characteristic, characteristics, and/or combinations of characteristics the user wants demographic statistics about. Based upon such user input, the software of some embodiments of the present invention will compute and display demographic statistics about the requested characteristic, characteristics, and/or combinations of characteristics. In some embodiments the demographic characteristics supported include one or more of (and/or one or more combinations of) user gender, age, marital status, couple status, political bent, political party affiliation, musical tastes, sexual orientation, sports team preferences, school affiliation, organizational affiliation, status as a local or visitor to a particular current location, city of residence, state of residence, country of residence, and/or primary language spoken.

In this way a first user 101 may traverse the physical world and be provided with a display in numerical and/or graphical form that represents the demographic makeup of other users 120 within his or her immediate surroundings 150. For example a user may view the percentage of males versusfemales within certain proximity of his or her current physical location by looking upon the display of his or her portable computing device. Similarly a user may view the percentage of Democrats versus Republicans within certain proximity of his or her current physical location by looking upon the display of his or her portable computing device. Similarly a user may view the percentage of locals versus visitors within certain proximity of his or her current physical location by looking upon the display of his or her portable computing device. Similarly a user may view the percentage of singlefemales between the ages of 19 and 29 within certain proximity of his or her current physical location by looking upon the display of his or her portable computing device. In such an embodiment a combination of three demographic characteristics are used in combination—gender, age, and marital status, when computing and displaying the desired demographic statistics to the user. Thus a user may request demographic statistics for a local proximity using the highly customizable interface of some embodiments of the present invention.

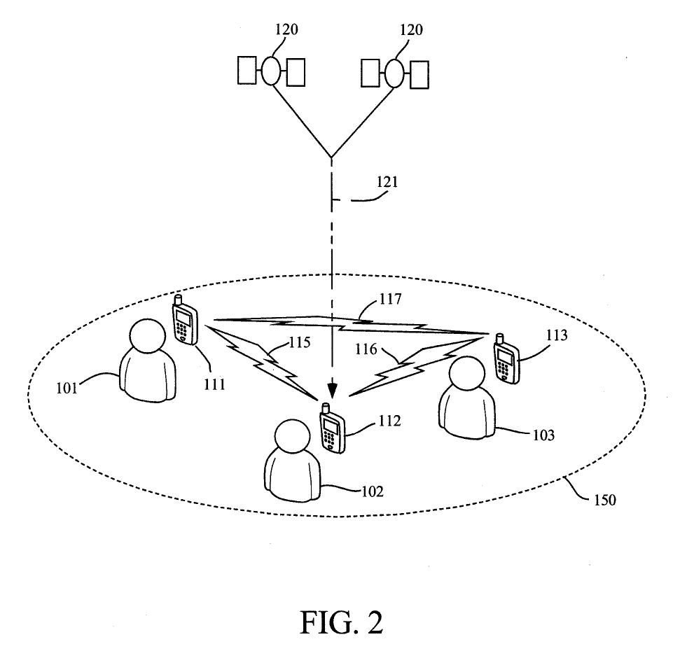

Referring next to FIG. 2, illustrated is an example communication architecture configured among a plurality of portable computing devices of some embodiments of the present invention. As used herein, “portable computing device” should be broadly construed as including any mobile wireless client device, e.g., a cell phone, pager, a personal digital assistant (PDA, e.g., with GPRS NIC), a mobile computer with a smart phone client, or the like. The portable computing devices of some embodiments of the present invention are equipped with a wireless networking technology that enables them to automatically form and maintain ad-hoc networks with other such devices within certain proximity. A variety of wireless ad-hoc network technologies may be employed, although for the purposes of this disclosure Bluetooth networking technology is used as the enabling example technology.

The portable computing devices of some embodiments of the present invention may also include additional forms of wireless communication. A typical portable computing device is a wireless access protocol (WAP)-enabled device that is capable of sending and receiving data in a wireless manner using the wireless application protocol. The wireless application protocol (“WAP”) allows users to access information via wireless devices, such as mobile phones, pagers, two-way radios, communicators, and the like. WAP supports wireless networks, including CDPD, CDMA, GSM, PDC, PHS, TDMA, FLEX, ReFLEX, iDEN, TETRA, DECT, DataTAC, and Mobitex, and it operates with many handheld device operating systems, such as PalmOS, EPOC, Windows CE, FLEXOS, OS/9, and JavaOS. Typically, WAP-enabled devices use graphical displays and can access the Internet (or other communication network) on so-called mini- or micro-browsers, which are web browsers with small file sizes that can accommodate the reduced memory constraints of handheld devices and the low-bandwidth constraints of a wireless networks. In a representative embodiment, the mobile device is a cellular telephone that operates over GPRS (General Packet Radio Service), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. In an illustrated embodiment, mobile device users use SMS, which is a text message service that enables short messages (e.g., generally no more than 140-160 characters in length) to be sent and transmitted from a portable computing device. Some embodiments of the present invention are not limited to mobile device users who have WAP-enabled devices or to use of any particular type of wireless network. Such devices and networks are merely illustrative; any wireless data communication technology now known or hereafter developed may be used in connection with some embodiments of the invention that are now described in more detail.

To enable the inventive features of some embodiments of the present invention, specialized software runs upon each portable computing device, moderating the data collection, data processing, and demographic statistics display features and functions. Such an application may take a wide variety of forms and is hereby called a demographic profiling application (DPA). In some embodiments, each of said portable computing devices may also configured with a locative sensor by which the device may receive or derive coordinate data that indicates the current spatial location of that portable computing device within a the real physical world. While a number of locative sensor technologies may be used to support some embodiments of the present invention, the present disclosure references GPS transducers as enabling examples of such a locative sensor. Each of said portable computing devices may also configured with an orientation sensor such that its orientation may be tracked in real-time. While a number of orientation sensor technologies may be used to support some embodiments of the present invention, the present disclosure references Magnetometer transducers as enabling examples of such an orientation sensors. Each of said portable computing devices is also equipped with a wireless peer-to-peer networking technology and configured such that the portable computing devices will automatically form ad-hoc networks amongst themselves when brought within certain proximity. While a variety of peer-to-peer networking technologies may be used to support some embodiments of the present invention, the present disclosure references Bluetooth as the enabling example of such a technology. Thus some embodiments of the present invention may be viewed as a plurality of Bluetooth enabled portable computing devices that are configured to automatically form ad-hoc networks amongst themselves when brought within certain proximity.

As described herein, the demographic profiling application (DPA) running upon each of said plurality of portable computing devices of some embodiments of the present invention is operative to exchange demographic characteristic data about its user with other of said plurality of portable computing devices of some embodiments of the present invention when the devices form an ad-hoc network between them. For the DPA running upon each portable computing device, the exchange process has two part—(i) reading a current user profile from memory on board the portable computing device and sending demographic characteristic information derived from that user profile to the other of said plurality of portable computing devices, and (ii) receiving demographic characteristic information from each of the other of said plurality of portable computing devices, either directly or through one or more intervening portable computing devices, along with unique identifying data for the source of the demographic characteristic information and storing a representation of said information in local memory. The demographic characteristic information stored in local memory generally includes the unique identifier for the device that supplied the information such that each unique device within the environment can be independently tracked and duplicate datasets are not interpreted as being associated with different devices. A time history of demographic characteristic information for each may also be stored. This may be performed by recording a history of demographic characteristic information received along with a time-stamp. In addition locative sensor data from GPS devices on board one or more of said portable computing devices may be exchanged and stored. In addition demographic data received may be stored along with a location-stamp that reflects the GPS location of the receiving portable computing device at the time the demographic characteristic data was received from another device. In this way statistics can be computed that determine how demographic profile qualities vary with location within the physical world.

Thus when a portable computing device of some embodiments of the present invention comes within certain proximity of another portable computing device of some embodiments of the present invention, one or more ad-hoc networks are formed among them and demographic characteristic information is automatically and exchanged between them along with unique identifier information and optionally along with locative data. This information and data is stored in a local database. When the devices are no longer within certain proximity, the data is removed from the database. In this way each of said portable computing devices creates and maintains a local data store (referred to herein as a Local Demographic Datastore ) that includes a representation demographic characteristics for a plurality of users of other enabled portable computing devices currently within a certain local proximity. In some embodiments the Local Demographic Datastore also includes a time-history of recent demographic characteristic information and/or a spatial history of recent demographic characteristic information for other portable computing devices.

With respect to the user profile information accessed from local memory as described above, this information may include user profile information includes one or more demographic characteristics about the current user of the portable computing device such as the age, gender, interests, profession, political affiliation, organizational affiliations, school affiliations, team affiliations, job title, marital status, sexual orientation, height, weight, highest level of education, IQ, music preferences, sports team preferences, dietary preferences, hobbies, income, city of residence, state of residence, country of residence, primary language, couple status, and/or local versus visitor status for each user. The DPA application may also be operative to store access-preference information for each user, the access-preference information describing and/or limiting how other users may gain demographic information about with that user. For example, access-preference information may limit access to some or all personal information for a particular user only to other users who match certain criteria, possess certain characteristics, and/or meet certain security requirements. Similarly, access-preference information may limit communication with a particular user only to other users who match certain criteria, possess certain characteristics, and/or meet certain security requirements. In some embodiments said certain security requirements includes a particular user possessing a password or satisfying some other authentication. In some embodiments said certain criteria includes a particular user being a member of a particular network of friends or business associates.

Referring next to FIG. 2, some embodiments of the present invention are implemented by a plurality of portable computing devices (i.e. 111, 112, 113) that are used by a plurality of users (i.e. 101, 102, 103) and configured such that one or more wireless ad-hoc networks form among and between them when they are brought within certain proximity using, for example, a Bluetooth networking technology. In this example embodiment, the ad-hoc network is represented by wireless communication links 115, 116, and 117. As is shown in the figure, the ad-hoc network of this example enables each portable computing device to communicate directly with each other portable computing device within certain proximity. For standard Bluetooth of the current art, the proximity is generally 10 meters. It should be noted that in some embodiments the ad-hoc network may include multiple layers such that some devices can not communicate directly with other devices, but can exchange information through an intervening device. Such a multi-layered ad-hoc network may be used by some embodiments of the present invention to expand the range of the network. For example, in a crowded area such as a city street, bus station, dance club, or school, the area covered by a multi-layer ad-hoc network may far exceed the size of a single peer to peer network connection.

Referring back to FIG. 1, each portable computing device of some embodiments of the present invention has the ability to form, join, maintain, and otherwise participate in an ad-hoc network with other similar devices. Each portable computing device may also include a locative sensor for tracking its real-time physical location in the physical world. The locative sensor may take a variety of forms but often includes a GPS sensor. The GPS sensor accesses a set of overhead satellites (105) to accurately determine a current spatial location within the physical world for that portable computing device. In preferred embodiments the GPS sensor is integrated within or upon the portable computing device although it may also be a peripheral that is interfaced with the portable computing device. Because the portable computing device is generally kept on the person of the user of that portable computing device, the location of the portable computing device and the location of the user of the portable computing device are generally referred to herein interchangeably to mean the same thing. Each portable computing device may also include an orientation sensor such as a magnetometer.

As mentioned previously, a demographic profiling application (DPA) runs upon each of said plurality of portable computing devices (111, 112,113) of some embodiments of the present invention. One function of the DPA running upon each portable computing device is to automatically exchange demographic characteristic information with other of said plurality of portable computing devices when the devices form an ad-hoc network between them. Thus in the present example, devices 111, 112, and 113 are configured by said DPA to communicate their demographic characteristic information about their then current user to each of the other of said portable computing devices over said ad-hoc network. In some embodiments current location and/or orientation data is also communicated. In most embodiments a unique identifier is also communicated such that the demographic information received may be relationally associated with a particular portable computing device (or a particular user of that portable computing device) by said unique identifier. The unique identifier information may be coded such that the user of that device remains anonymous while still allowing the DPA software of some embodiments of the present invention running on a particular portable computing device to keep track of the number of unique devices within certain proximity. Note—in some embodiments the unique identifier is specific to the portable computing device that provides the demographic characteristic information. In other embodiments the unique identifier is specific to the user for whom the demographic characteristic information refers. In some embodiments two unique identifiers are used, one for each device and one for each user. Such embodiments are useful for situations in which a user may have more than one portable computing device upon his person. In such embodiments, by the unique identifier for the user may be used such that multiple sets of data provided by each device may not be double counted if they both have the same user-specific unique identifier.

Thus the DPA application running upon a first portable computing device may be operative at a particular moment in time to receive demographic characteristic information from, for example, 7 unique portable computing devices within a local space. The demographic information from the 7 unique portable computing devices are then stored in local memory of said first portable computing device by said DPA running upon that device, the store being referred to as the Local Demographic Datastore. The data may, for example, include the AGE and GENDER and MARITAL STATUS of each of the users of each of the 7 unique portable computing devices. The DPA may then compute demographic statistics based upon the data. This step may be performed periodically based upon user settings or may be performed in response to a specific user request such as a button press or other interaction with a user interface element of the first portable computing device. For example, the user may press a button or otherwise engage the user interface to request Current Gender Statistics for the user's local space. In response to this request, the DPA is operative to access the Local Demographic Datastore and compute statistics related to the gender of the users currently within the user's local surroundings. If, for example, 2 of the users are male and 5 of the users are female, the statistics computed may indicate 29% female and 71% male. This data may be displayed to the user of the first portable computing device as a textual display or as a graphical representation. The graphical representation could be, for example, a pie chart or bar graph representing the statistical information. Similarly, the user may press another button or engage a different element of the user interface to request Current Age Statistics for the user's local space. In response to this request, the DPA may be operative to access the Local Demographic Datastore and perform a histogram analysis related to the age groupings of the users currently within the user's local surroundings as stored in the data store. This analysis may indicate, for example, the percentage of users below 21 years old, the percentage of users between 22 and 35 years old, the percentage of users between 36 and 55 years old, and the percentage of users 56 and over. This data may be displayed to the user of the first portable computing device as a textual display or as a graphical representation. The graphical representation could be a histogram graph. In some embodiments the user may request statistical information related to a combination of demographic characteristics—for example both age and gender. In this way a user could, for example, request a statistical analysis and display regarding the number of male users between 22 and 35 years old. In response to such a user request (entered through the interface of the portable computing device), the DPA may perform an analysis that computes the percentage of users currently within certain proximity of the portable computing device that is both male and between 22 and 35 years old. This data may be displayed to the user of the first portable computing device as a textual display or as a graphical representation.

With respect to the demographic characteristic information that is passed between portable computing devices, stored in local data stores, and used in the computation of demographic statistics, a wide variety of characteristics may be used alone or in combinations. In common embodiments the demographic characteristic information includes one or more of age, gender, marital status, sexual orientation, personal interests, profession, political affiliation, organizational affiliations, school affiliations, team affiliations, job title, height, weight, highest level of education, IQ, music preferences, sports team preferences, dietary preferences, hobbies, income, city of residence, state of residence, country of residence, primary language, couple status, pet preferences, and/or local versus visitor status for each user. In this way a user can view one or more of the following example statistical assessments of the users within his or her local space (or any combination thereof)—percent male, percent female, percent married, percent unmarried, percent heterosexual, percent homosexual, percent of a particular age grouping, percent single, percent coupled, percent fans of a particular sport, percent fans of a particular sports team, percent liberal, percent conservative, percent democrat, percent republican, percent fans of a particular music genre, percent fans of a particular music group, percent members of a particular organization, percent students of a particular school, percent alumni of a particular school, percent locals of a certain region, percent visitors to a certain region, percent rock music fans, percent country music fans, percent vegetarians, percent dog lovers, percent Americans, percent Canadians, percent nationals, percent foreigners, percent French speakers, etc. . . . Note, while the above statistics are described as percentages, other representations may be employed such as the raw number of users who posses a certain demographic characteristic within their profile who reside within certain proximity of a portable computing device.

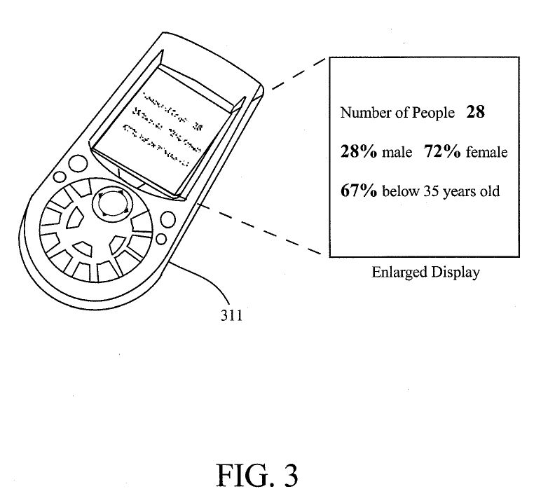

Referring next to FIG. 3, illustrated is a portable computing device 311 configured with appropriate hardware and software to support some embodiments of the inventions disclosed herein. The portable computing device is kept on the person of a first user 101 (not shown) who is then currently residing within a local space 150 (not shown) that includes a plurality of other users 120 (not shown). At the current moment in the, the portable computing device has formed one or more ad-hoc networks with the portable computing devices of said other users 120 such that demographic characteristic information is automatically exchanged between said portable computing device 311 and the portable computing devices of each of said other users 120, either by direct device-to-device communication or through an intervening device. In this way, portable computing device 311 has received over the ad-hoc network, which in this example is a Bluetooth network, demographic characteristic information about each of said other users 120, along with a unique identifier for each of said other users 120 (and/or a unique identifier for their portable computing device, and has stored such data with a Local Demographic Datastore within said portable computing device 311. This process was performed automatically by the Demographic Profiling Application (DPA) running upon the portable computing device 311 and is repeatedly updated such that as the user traverses the real physical world, thereby changing the physical location of local space 150 within the world, OR as other users enter and leave the local space 150, the Local Demographic Datastore is maintained in a substantially up to date form by the DPA automatically adding and removing demographic data relating to other users who enter and/or exit the local space 150. Thus at any moment in time the Local Demographic Datastore includes information for the substantially current demographic characteristics of the other users who then reside within local space 150. Note—substantially current does not mean perfectly currently. There will generally be a short time lag. Also note—historical data may also be kept within the Local Demographic Datastore but can be distinguished from substantially current data by time stamps as described previously.

The user 101 of portable computing device 311 may request a display of demographic statistics based upon the data stored within Local Demographic Datastore by interacting with a user interface of the portable computing device. In some embodiments the device may be configured to continually display certain demographic statistics. In other embodiments the device may be configured to display certain demographic statistics only upon explicit request from the user through the user interface. In either case, the user may configure the statistical display parameters by interacting with the user interface of device 311. For example, the user may select which demographic characteristics and/or which combinations of characteristics should be displayed in a statistical format to the user. The user may also select the form of the display—indicating for example, if the display should be textual or graphical. And if graphical indicating the style of display for each demographic statistic requested, for example, bar chart, pie chart, histogram chart, a graph over time, and a graph over location. In addition, when charts and graphs are used the user may select and/or identify which color, colors, or graphical pattern, is used to represent different demographic characteristics. For example, pink may be chosen in a chart or graph to represent female users and blue may be chosen to represent male users. In this way a bar chart or pie chart may be easily understandable with respect to gender statistics without requiring the user to read a text key. In some embodiments default colors are set for certain demographic statistic parameters. One common default used for some embodiments of the present invention includes setting pink as a primary color for female gender demographic statistic presentation and setting blue as a primary color for male gender demographic statistic presentation.

Referring back to FIG. 3, the portable computing device of the current example has been set to display demographics in textual form and has been configured to display the total number of people within local space 150, the percentage that is male, the percentage that is female, and the percentage that is below 35 years old. The text may be displayed in black as shown, or may be color coded as described above—for example blue text being used for male gender statistic presentation and pink text being used for female gender statistic presentation. An example screen display is shown as an enlargement window 399. As shown in 399, the textual display indicates that at the current moment in time, the local space 150 includes 28 people (i.e. 28 users of enabled portable computing devices). 28% are male. 72% are female. And 67% are under 35 years old. The user can configure the device to display these statistics upon a certain user input command, such as upon a button press. The user can also configure the device to display the statistics over time, continually updating the presentation as the data changes within the Local Demographic Datastore of portable computing device 311. The user can also configure the device to display statistics that represent not the current moment in time, but a window in time that extends back some number of minutes. For example, the user can view the average demographic makeup of users within local space 150 over the last 20 minutes by setting the time window to 20 minutes and requesting a time-average of demographic statistics. Alternately the user can view the cumulative demographic makeup of the user within local space 150 over a window in time, for example the last 20 minutes, by requesting cumulative demographic statistics and by setting the time window to 20 minutes.

When performing a time-averaged demographic statistics function over a designated time window, the DPA will compute the average number of unique users that were present within the local space 150 (which may move over time) over the time window and compute the time-average percentage of those unique users who have designated demographic characteristics or combinations of characteristics. In this way the DPA can display to the user, for example, the time-averaged number of users who were detected within local space 150 during the last 20 minutes, the time-averaged percentage of those users who are male, and the time-averaged percentage of those users who are female. In this way the user of portable computing device 311 can quickly review the average gender makeup of local space 150 during the designated time window. The same can be done for any tracked demographic characteristic or combination of characteristics.

When performing a cumulative demographic statistics function over a designated time window, the DPA will compute the total number of unique users that were detected within the local space 150 (which may move over time) during the time window and compute the percentage of those unique users who have designated demographic characteristics or combinations of characteristics. In this way the DPA can display to the user, for example, the total number of users who were detected within local space 150 over the last 20 minutes, the percentage of those users who are male, and the percentage of those users who are female. In this way the user of portable computing device 311 can quickly review the cumulative gender makeup of the unique users who were detected within local space 150 during the designated time window. The same can be done for any tracked demographic characteristic or combination of characteristics.

Time Thresholding—in some embodiments of the present invention a time threshold can be established such that a user detected within local space 150 is not added to the demographic statistics unless that user is determined by the DPA to be present within local space 150 for more than some threshold amount of time. This is useful in distinguishing between users who just pass through local space 150 momentarily as compared to users who are present within local space 150 for an extended period of time. For example, a user can set a time threshold value to 2 minutes such that only users who are present within local space 150 for more than 2 minutes are counted within the demographic statistics, thereby culling out users who may just be walking by. This is useful for example, when a user is in a street cafe and wants to determine the makeup of the patrons and not include those folks who may be passing by on the street.

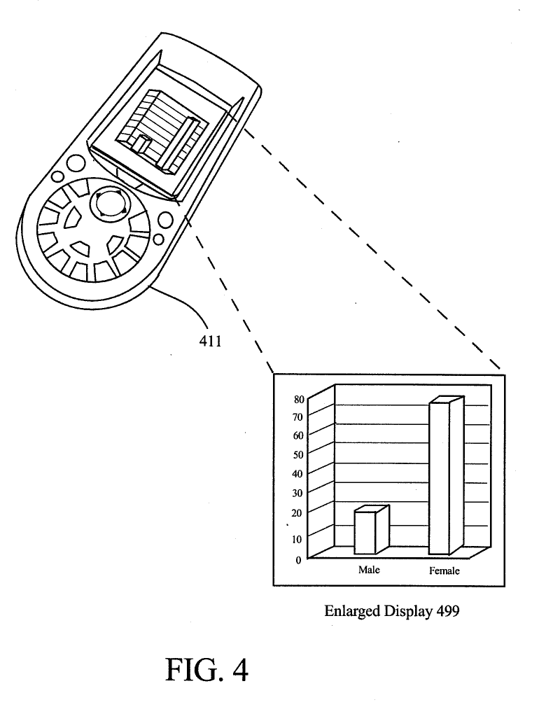

Referring next to FIG. 4, the portable computing device 411 of the current example is now set to display demographic statistics in graphical form and has been configured to display the percentage of detected users that are male versus percentage of detected users that are female as a bar chart upon the screen of the portable computing device. The bars of the chart may be displayed in a solid color as shown, or may be color coded to distinguish between characteristics. For example blue may be used for the bar representing male gender and pink may be used for the bar representing female gender. An example screen display is shown as an enlargement window 499. As shown in 499, the bar chart display indicates that at the current moment in time 28% of detected users are male and 72% of detected users female. The user can configure the device to display these statistics upon a certain user input command, such as upon a button press. The user can also configure the device to display the statistics over time, continually updating the presentation as the data changes within the Local Demographic Datastore of portable computing device 411. The user can also configure the device to display statistics that represent not the current moment in time, but a window in time that extends back some number of minutes. For example, the user can view the average demographic makeup of users within local space 150 over the last 20 minutes by setting the time window to 20 minutes and requesting a time-average of demographic statistics. Alternately the user can view the cumulative demographic makeup of the user within local space 150 over a window in time, for example the last 20 minutes, by requesting cumulative demographic statistics and by setting the time window to 20 minutes.

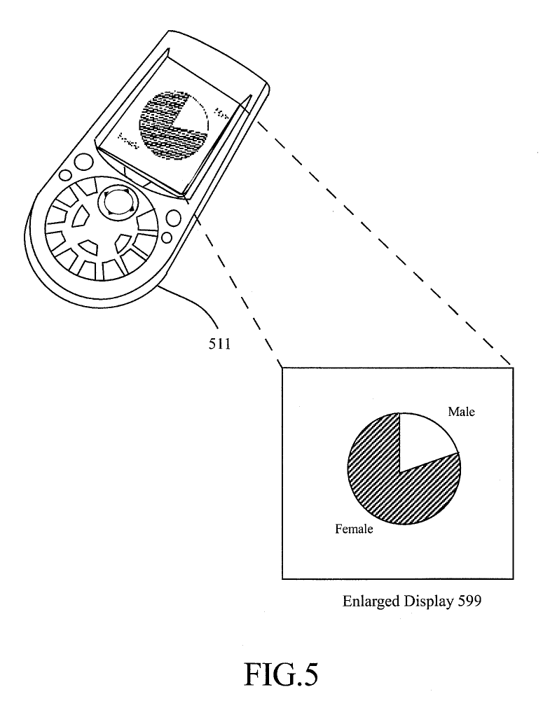

Referring next to FIG. 5, the portable computing device 511 of the current example is now set to display demographic statistics in graphical form and has been configured to display the percentage of detected users that are male versus percentage of detected users that are female as a pie chart upon the screen of the portable computing device. The areas of the pie chart may be may be color coded to distinguish between characteristics. For example blue may be used for the area representing male gender and pink may be used for the area representing female gender. An example screen display is shown as an enlargement window 599. As shown in 599, the pie chart display indicates that at the current moment in time 28% of detected users are male and 72% of detected users female. The user can configure the device to display these statistics upon a certain user input command, such as upon a button press. The user can also configure the device to display the statistics over time, continually updating the presentation as the data changes within the Local Demographic Datastore of portable computing device 511. The user can also configure the device to display statistics that represent not the current moment in time, but a window in time that extends back some number of minutes. For example, the user can view the average demographic makeup of users within local space 150 over the last 20 minutes by setting the time window to 20 minutes and requesting a time-average of demographic statistics. Alternately the user can view the cumulative demographic makeup of the user within local space 150 over a window in time, for example the last 20 minutes, by requesting cumulative demographic statistics and by setting the time window to 20 minutes.

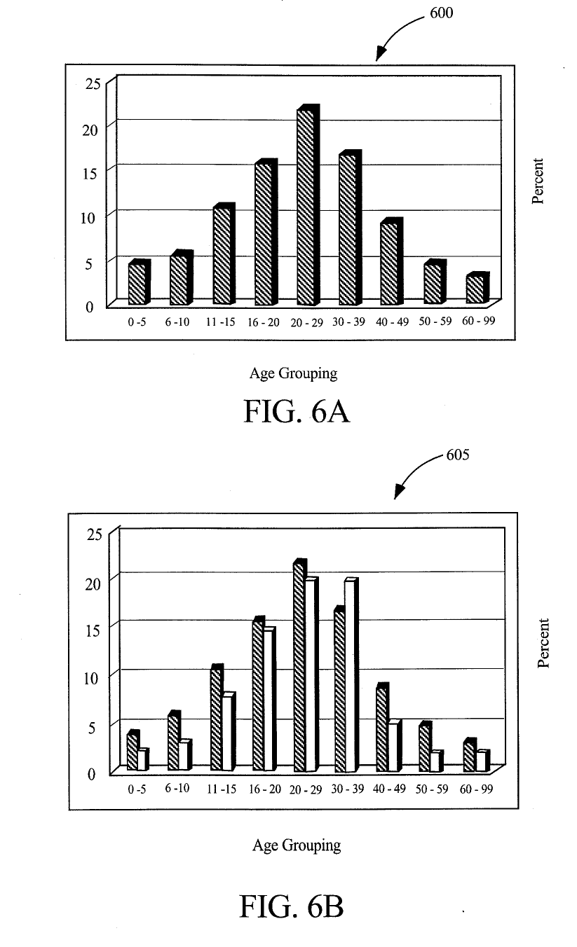

Referring next to FIG. 6a and FIG. 6b additional example demographic statistic display screens are provided, both representing a histogram analysis of the users within local space 150 with respect to certain designated age groupings. These age groupings are sometimes referred to as “bins” within a histogram statistical analysis. As shown, the age groupings used for the statistical analysis and display include the following age ranges: 0-5, 6-10, 11-15, 16-20, 21-29, 30-39, 40-49, 50-59, and 60-99. The DPA will perform a statistical analysis such that the number of users that fall into each age range is summed and reported in graphical form. It may be reported as a bar graph of the actual numbers that fall into each range or as a bar graph of the relative percentages of users that fall into each age range. An example of such a bar graph 600 is presented as FIG. 6a as it might appear upon the screen of a portable computing device of some embodiments of the present invention. Thus a user may look at the screen and quickly view the relative age distribution of users within local space 150. In this particular example the distribution of the bar graph 600 makes it clear that the users are mostly in their late teens through late thirties, with much fewer users at the younger and older age ranges. This is a fast and convenient way for a user to visualize the age-wise demographic makeup of users within his or her local proximity.

In some situations a user may wish to view multiple demographic characteristics at the same time in a fast and convenient form. For example, a user may wish to view the overall age-wise demographic makeup of users within his or her local space as well as view information regarding the gender makeup of users within each age range. To perform such an analysis, the DPA may be configured to perform a histogram analysis with respect to age range, separately for each gender. For example the DPA will perform a first histogram statistical analysis such that the number of MALES that fall into each age range is summed and a second histogram statistical analysis such that the number of FEMALES that fall into each age range is summed. The results may be reported together in a graphical form using a histogram wherein two bars are shown for each age range, one bar for males and one bar for females. The male bars may be shown in one color (for example blue) and the female bars may be shown in another color (for example pink), to make the gender related age statistics easily visually apparent. The bar graph data may be reported of the actual number of each gender users that fall into each range or as the percentage of each gender users that fall into each age range.

An example of such a bar graph 605 is presented as FIG. 6b as it might appear upon the screen of a portable computing device of some embodiments of the present invention. Thus a user may look at the screen and quickly view the relative age distribution of both MALE users and FEMALE users within local space 150. In this particular example, the MALE users are represented by the dark bars and the FEMALE users are represented by the light bars. This is a fast and convenient way for a user to visualize the age-wise demographic makeup of the male users and the female users (independently) within his or her local proximity. Similar methods may be used for other pairings of demographic characteristics. For example, a similar graph may be used to display an age histogram for each of both DEMOCRAT and REPUBLICAN users. Similarly, a graph may be used to display an age histogram for each of both MARRIED and UNMARRIED users. Similarly, a graph may be used to display an age histogram for each of both COUPLED users (i.e. in a relationship) and SINGLE users (i.e. not in a relationship). Similarly, a graph may be used to display an age histogram for each of both LOCALS (i.e. users living near to the current location of local space 150) and VISITORS (i.e. users visiting the area from some other place).

The user of the portable computing device can configure the device to display such statistics upon a certain user input command, such as upon a button press. The user can also configure the device to display the statistics over time, continually updating the presentation as the data changes within the Local Demographic Datastore of portable computing device. The user can also configure the device to display statistics that represent not the current moment in time, but a window in time that extends back some number of minutes. For example, the user can view a histogram of the average demographic makeup of users within local space 150 over the last 20 minutes by setting the time window to 20 minutes and requesting a time-average of demographic statistics. Alternately the user can view a histogram of the cumulative demographic makeup of the user within local space 150 over a window in time, for example the last 20 minutes, by requesting cumulative demographic statistics and by setting the time window.

Note, in some embodiments locative data from GPS sensors on board each portable computing device may be used to determine the proximity of each of said other users to the user of said first portable computing device. In such embodiments the demographic statistics may be computed and/or displayed with regard to proximity to the user of said first portable computing device. For example a histogram may be presented to the user wherein the bins represent different distance ranges from said user of said user of said first portable computing device. In this way a user can get a sense not only of the relative makeup of the local users with respect certain demographic characteristics, but also be provided with information about the spatial layout of such users within local space 150. Note, the determination of the actual spatial proximity of a particular user with respect to the user of said first portable computing device may be performed by using simple vector math upon the current location of said first user (as determined by the GPS sensor on board his or portable computing device) and the current location of said other user (as determined by the GPS sensor on board his or her portable computing device).

In some embodiments the spatial data from a locative sensor (for example a GPS sensor) is used to provide relative location information, for example providing demographic statistics with respect to users who are northbound, southbound, eastbound, and/or westbound of the user of said first portable computing device within the local space 150. This may be used to enable said user to determine, for example, how the percentage of single male users between 18 and 29 varies with respect to different spatial directions in the local space 150. By knowing, for example, that a higher percentage of such users reside in the northbound direction, the user may walk north if he or she desires to encounter such types of users. Note, the determination of the relative direction of a particular user with respect to the user of said first portable computing device may be performed by using simple vector math upon the current location of said first user (as determined by the GPS sensor on board his or portable computing device) and the current location of said other user (as determined by the GPS sensor on board his or her portable computing device).

Thus, as described herein, a user is enabled by some embodiments of the present invention to quickly and conveniently view demographic information relating to the statistical makeup of a group of other users within certain proximity or within a certain local area of that user. The statistical makeup may be displayed with respect to one or more demographic characteristics, optionally including combinations of characteristics. The statistical makeup may also be displayed with respect to relative proximity and/or direction information derived from locative sensors on board the portable computing devices.

While the invention herein disclosed has been described by means of specific embodiments, examples and applications thereof, numerous modifications and variations could be made thereto by those skilled in the art without departing from the scope of the invention set forth in the claims.

What is claimed is:

1. A system for mobile demographic profiling across ad-hoc networks, comprising:
a first portable computing device operated by a first user, the first portable computing device including a processor, a memory, a display, and a wireless communication transceiver, the wireless communication transceiver enabling the establishment of an ad-hoc network with a plurality of second portable computing devices;
wherein the processor of the first portable computing device is operative to:
receive user profile data originating from each of the plurality of second portable computing devices over the ad-hoc network, the user profile data indicating at least one demographic characteristic of one of a plurality of users of the plurality of second portable computing devices;
store a representation of demographic data received;
compute a statistical demographic profile of the plurality of users of the plurality of second portable computing devices using the demographic data received; and
display a representation of the statistical demographic profile on the display of the first portable computing device.

2. The system of claim 1 further comprising first user profile data, the first user profile data indicating at least one demographic characteristic of the first user, wherein the statistical demographic profile is computed using the first user profile data.

3. The system of claim 1 wherein the user profile data originating from each second portable computing device is relationally associated with a unique identifier.

4. The system of claim 1 wherein the user profile data originating from each second portable computing device indicates a plurality of demographic characteristics of a user of that second portable computing device.

5. The system of claim 4 wherein the plurality of independent demographic characteristics includes at least one gender demographic characteristic and one age demographic characteristic.

6. The system of claim 1 wherein the at least one demographic characteristic is selected from the group consisting of age, gender, highest level of education, marital status, political party affiliation, school affiliation, team affiliation, club affiliation, organization affiliation, sexual orientation, romantic relationship status, nationality, and sporting team preference.

7. The system of claim 1 wherein the statistical demographic profile includes an indication of a percentage of users who posses a certain demographic characteristic in their user profile data.

8. The system of claim 1 wherein the statistical demographic profile includes an indication of a percentage of users who posses both of two different demographic characteristics in their user profile data.

9. The system of claim 8 wherein the two different demographic characteristics include a gender characteristic and an age characteristic.

10. The system of claim 1 wherein the representation of the statistical demographic profile is a graph or chart indicating how the at least one demographic characteristic varies across the plurality of users.

11. The system of claim 10 wherein the graph or chart is displayed in at least one of histogram format and pie chart format.

12. The system of claim 1 wherein the plurality of second portable computing devices to be included within the statistical demographic profile is determined at least in part based upon locative data associated with each of the plurality of second portable computing devices.

13. The system of claim 12 wherein one of the plurality of second portable computing devices is included within the statistical demographic profile at least in part based upon a spatial proximity of the one of the plurality of second portable computing devices to the first portable computing device.

14. The system of claim 12 wherein the plurality of second portable computing devices to be included within the statistical demographic profile is determined at least in part based upon the locative data indicating that the plurality of second portable computing devices resides within the group consisting of a spatial area and volume.

15. A method for mobile demographic profiling across ad-hoc networks, comprising:
receiving at a first portable computing device user profile data originating from each of a plurality of second portable computing devices over an ad-hoc network, the user profile data originating from each second portable computing device indicating at least one demographic characteristic of a current user of that second portable computing device;
storing a representation of demographic data received;
computing a statistical demographic profile of the plurality of users of the plurality of second portable computing devices using the demographic data received; and
displaying a representation of the statistical demographic profile on a display of the first portable computing device.

16. The method of claim 15 wherein the received user profile data from each of the plurality of second portable computing devices is relationally associated with a unique identifier.

17. The method of claim 15 wherein the received user profile data originating from each second portable computing device indicates a plurality of demographic characteristics of the current user of that second portable computing device.

18. The method of claim 17 wherein the plurality of independent demographic characteristics includes at least one gender demographic characteristic and one age demographic characteristic.

19. The method of claim 15 wherein the at least one demographic characteristic is selected from the group consisting of age, gender, highest level of education, marital status, political party affiliation, school affiliation, team affiliation, club affiliation, organization affiliation, sexual orientation, romantic relationship status, nationality, and sporting team preference.

20. The method of claim 15 wherein the statistical demographic profile includes an indication of a percentage of users who posses the group consisting of a certain demographic characteristic in their user profile data and a certain combination of demographic characteristics in their user profile data.

21. The method of claim 15 wherein the displaying step consists of displaying a graph or chart indicating how at least one demographic characteristic varies across a population of users.

22. The method of claim 21 wherein the graph or chart is displayed in at least one of histogram format and pie chart format.

23. The method of claim 15 wherein the plurality of second portable computing devices to be included within the statistical demographic profile is determined at least in part based upon locative data associated with each of the plurality of second portable computing devices.

24. The method of claim 23 wherein one of the plurality of second portable computing devices is included within the statistical demographic profile at least in part based upon a spatial proximity of the one of the plurality of second portable computing to the first portable computing device.

25. The method of claim 15 wherein one of the plurality of second portable computing devices is included within the statistical demographic profile at least in part based upon the number of network hops between the first portable computing device and the one of the plurality of second portable computing devices.

26. A method for demographic profiling across portable computing devices, comprising:
receiving on a first portable computing device, user profile data originating from each of a plurality of second portable computing devices, the user profile data originating from each second portable computing device indicating at least one demographic characteristic of a user of that second portable computing device;
computing a statistical demographic profile describing a plurality of users of the plurality of second portable computing devices, the computing being performed using the user profile data received; and
displaying a representation of the statistical demographic profile of the plurality of users at the first portable computing device, the representation indicating how the plurality of users vary statistically with respect to the at least one demographic characteristic.

27. The method of claim 26 wherein the received user profile data originating from each second portable computing device describes a plurality of independent demographic characteristics of the user of that second portable computing device.

28. The method of claim 27 wherein the plurality of independent demographic characteristics includes at least one gender demographic characteristic and at least one age demographic characteristic.

29. The method of claim 26 wherein the statistical demographic profile is an indication of a percentage of users who posses a certain demographic characteristic or a certain combination of demographic characteristics within their user profile data.

30. The method of claim 26 wherein the displaying step consists of displaying a graph or chart on a display.

31. The method of claim 30 wherein the graph or chart is displayed in at least one of histogram format and pie chart format.

32. The method of claim 26 wherein the plurality of second portable computing devices that are to be included within the statistical demographic profile is determined at least in part based upon locative data associated with each of the plurality of second portable computing devices.
